(19) United States
(12) Patent Application Publication
(10) Pub. No.: US 2013/0174029 A1
(43) Pub. Date: Jul. 4, 2013

(54) METHOD AND APPARATUS FOR ANALYZING A DOCUMENT

(71) Applicants: Thomas O'Sullivan, Woodridge, IL (US); Andrzej Jachowicz, Tower Lakes, IL (US)

(72) Inventors: Thomas O'Sullivan, Woodridge, IL (US); Andrzej Jachowicz, Tower Lakes, IL (US)

(73) Assignee: Freedom Solutions Group, LLC d/b/a Microsystems, Downers Grove, IL (US)

(21) Appl. No.: 13/343,423

(22) Filed: Jan. 4, 2012

(51) Int. Cl. G06F 17/00

(52) U.S. Cl. 715/256

(57) ABSTRACT

Method, apparatus, and computer-readable medium are provided for analyzing a document including text. In one example, the method includes obtaining the text from the document to provide obtained text, generating a plurality of indices representative of the obtained text, generating a user interface including at least a portion of the obtained text based on the plurality of indices, monitoring the document for a change in the text, updating the plurality of indices to reflect the change to provide updated indices in response to detecting a change in the text, updating the plurality of indices to reflect the change to provide updated indices, and generating an updated user interface based on the updated indices without user intervention.

### FIELD

The present disclosure relates to a method and apparatus for analyzing a document.

### BACKGROUND

Tools exist to aid with electronic document analysis, proofreading, and editing. Generally, such tools are software programs capable of interfacing with word processing software (e.g., Microsoft Word™) used to create the electronic document. For example, conventional tools are capable of obtaining extensive information about electronic documents that are normally opened in a word processing software program. This information may include characteristics describing the electronic document itself and/or characteristics describing the electronic document's text.

With regard to characteristics describing an electronic document itself, these characteristics may include information describing the number of paragraphs in the document, the size of the document, the creation date of the document, the last edit date of the document, security restrictions associated with the document, the file name of the document, etc. With regard to characteristics describing the electronic document's text, these characteristics may include information describing “primary attributes” of the text (e.g., whether specific text is capitalized and positional information regarding the text) and “secondary attributes” of the text (e.g., whether specific text is italicized, bolded, and/or underlined, the font size of specific text, the font type of specific text, etc.).

After obtaining characteristics describing an electronic document itself and the text within a given electronic document, these conventional tools analyze the text and the characteristics in order to provide additional useful information about the document. Frequently, this additional useful information is provided via a user interface, such as a graphical user interface displayed on a display screen. In this manner, a person using such a conventional tool can review the useful additional information and make changes to the underlying electronic document as needed. By way of example and not limitation, such additional useful information may include the following information about a given electronic document: information identifying all of the defined terms in the document, information identifying potentially inconsistent uses of phrases within the document, information identifying possible editing mistakes within the document, information identifying possible incomplete segments of the text within the document, etc.

The user interface that displays the useful additional information is often provided in a manner that allows it to be viewed simultaneously with the electronic document itself. Furthermore, the user interface is frequently interactive, such that if a user selects (e.g., by clicking a mouse) a particular piece of information being displayed in the user interface (e.g., a particular defined term among a list of defined terms), the view of the document in the word processing software user interface will change to, e.g., show the first instance of the defined term that was selected within the document. Accordingly, existing tools for performing document analysis, editing, and proofreading provide useful mechanisms for ensuring consistency and preventing ambiguity within electronic documents such as legal contracts.

However, existing tools for performing document analysis, editing, and proofreading also suffer from a number of drawbacks. For example, existing tools for performing document analysis, editing, and proofreading are known to require user intervention in order to update the tool's user interface after a change has been made to the text in the underlying document under analysis. Accordingly, a need exists for a method and apparatus designed to generate an updated user interface for displaying additional useful information without user intervention following a change to the text of the electronic document under analysis.

### SUMMARY

The instant disclosure describes techniques and an apparatus for analyzing a document including text. In one embodiment, an apparatus includes at least one processing device and memory operatively connected to the at least one processing device. The memory includes executable instructions capable of execution by the at least one processing device. Executing these executable instructions causes the at least one processing device to: (i) obtain the text from the document to provide obtained text; (ii) generate a plurality of indices representative of the obtained text; (iii) generate a user interface including at least a portion of the obtained text based on the plurality of indices; (iv) monitor the document for a change in the text; (v) in response to detecting a change in the text, update the plurality of indices to reflect the change to provide updated indices; and (vi) generate an updated user interface based on the updated indices without user intervention.

In one example, the executable instructions, when executed, cause the at least one processing device to generate a plurality of indices representative of the obtained text by causing the at least one processing device to generate at least one document-level index and at least one paragraph-level index.

In one example, the executable instructions, when executed, cause the at least one processing device to generate at least one document-level index by causing the processing device to generate a normalized word index, a non-normalized word index, a normalized character index, and/or a non-normalized character index. In another example, the normalized word index and the non-normalized word index each include indices representative of all words in the obtained text. In this example, the normalized word index may exclude capitalization information associated with the obtained text. In still another example, the normalized character index and the non-normalized character index each include indices representative of all characters in the obtained text. In this example, the normalized character index may exclude capitalization information associated with the obtained text.

In one example, the executable instructions, when executed, cause the at least one processing device to generate at least one paragraph-level index by causing the processing device to generate a normalized word index, a non-normalized word index, a normalized character index, and/or a non-normalized character index. In another example, the normalized word index and the non-normalized word index each include indices representative of all words within at least one paragraph of the obtained text. In this example, the normalized word index may exclude capitalization information associated with the obtained text. In still another example, the normalized character index and the non-normalized character index each include indices representative of all characters within at least one paragraph of the obtained text. In this example, the normalized character index may exclude capitalization information associated with the obtained text.

In one example, the executable instructions, when executed, cause the at least one processing device to update the plurality of indices to reflect the change to provide updated indices by causing the at least one processing device to (i) obtained changed text from the document and (ii) modify the plurality of indices, such that the modified plurality of indices are representative of the changed text.

In another example, the executable instructions, when executed, cause the at least one processing device to monitor the document for a change in the text by causing the at least one processing device to listen for a change event.

Related methods and computer-readable media are also disclosed.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally depicting one example of an apparatus in accordance with the present disclosure.

FIG. 2 is a block diagram generally depicting one example of document-level indices and paragraph-level indices in accordance with the present disclosure.

FIG. 3 illustrates one example of a user interface that may be generated and updated in accordance with the present disclosure.

FIG. 4 is a flowchart generally depicting one example of a method for analyzing a document in accordance with the present disclosure.

FIG. 5 is a block diagram generally depicting one example of a processing device that may be used to implement the teachings of the present disclosure.

FIG. 6. Illustrates one example of a plurality of indices representative of obtained text.

FIG. 7. Illustrates another example a plurality of indices representative of obtained text following a change to the text.

### DETAILED DESCRIPTION

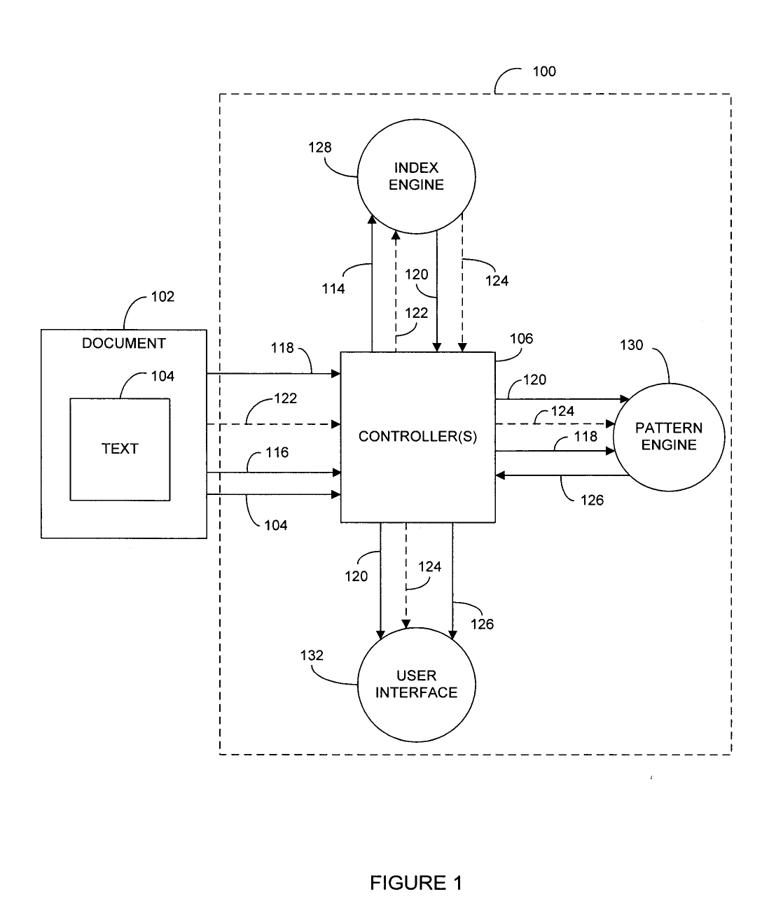

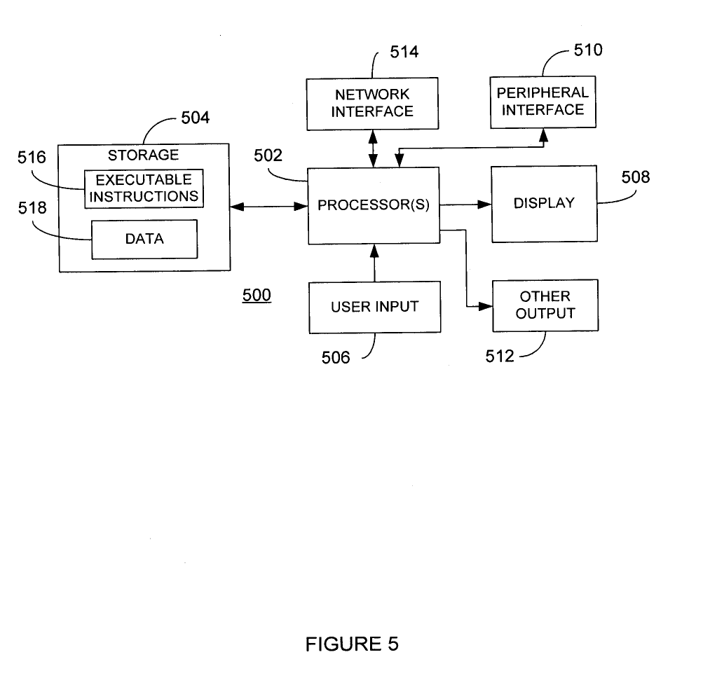

The following description of the embodiments is merely exemplary in nature and is in no way intended to limit the disclosure, its application, or uses. FIG. 1 illustrates an apparatus 100 for analyzing a document 102 including text 104 in accordance with the present disclosure. As used herein, a document, such as document 102, includes any electronic document capable of being viewed using any known word processing program. Apparatus 100 includes one or more controllers 106, an index engine 128, a pattern engine 130, and a user interface 132. In practice, the functionality of apparatus 100 may be implemented, for example, using the device 500 of FIG. 5 as described below. In one example, the index engine 128 and pattern engine 130 may comprise software modules configured to perform the functionality described herein when executed by a suitable processing device, such as device 500 of FIG. 5. In one example, the user interface 132 is implemented as display data configured for display on a suitable display device, such as display 508 of FIG. 5.

Via the controller(s) 106, apparatus 100 is configured to communicate with, for example, a word processing program (e.g., Microsoft Word™; not shown) that has an electronic document 102 opened in it. Although controller(s) 106 are illustrated as being directly connected to document 102, those having ordinary skill in the art will appreciate that information 104, 116, 118, 122 may be communicated between the document 102 and apparatus 100 over one or more private or public communication networks, databus(ses), or other communication channels equally well using suitable techniques known in the art.

The illustrated controller(s) 106 operate to interact with and manage communications between the document 102, index engine 128, pattern engine 130, and user interface 132. For example, the controller(s) 106 obtain text 104 from the document 102 to provide obtained text 114. In one example, the text 104 is automatically furnished from the word processing program within which the document 102 is open to the apparatus 100 (i.e., pushed) in order to provide the obtained text 114. However, in another embodiment, the apparatus 100 fetches the text 104 from the document 102 (i.e., pulls the text 104) in order to provide the obtained text 114. In either case, techniques for obtaining text 104 from a document 102 opened in a word processing program are well known to those having ordinary skill in the art (e.g., via a suitable application programming interface (API)) and will not be discussed in additional detail in the instant disclosure.

Controller(s) 106 are further operative to provide the obtained text 114 to the index engine 128. The index engine 128 is operative to generate a plurality of indices representative of the obtained text 120. In one example, the index engine 128 is operative to generate at least one document-level index and at least one paragraph-level index. For example, in an embodiment, the index engine 128 parses the obtained text 114 from beginning to end to identify occurrences of new paragraphs. Each new occurrence of a paragraph is created as a new entry in the at least one paragraph-level index. While the instant disclosure discusses generating indices on a document-level and a paragraph-level, other levels of abstraction (e.g., sentence-level, word-level, character-level) may be equally employed as a design choice. Furthermore, the instant disclosure recognizes that it may be desirable to generate one or more paragraph-level indices that only contain paragraphs from the document's text 104 that are numbered. In this example, the indices may include both the number assigned to that paragraph (e.g., “5” for the fifth numbered paragraph in a document 102) as well as the text included within that paragraph.

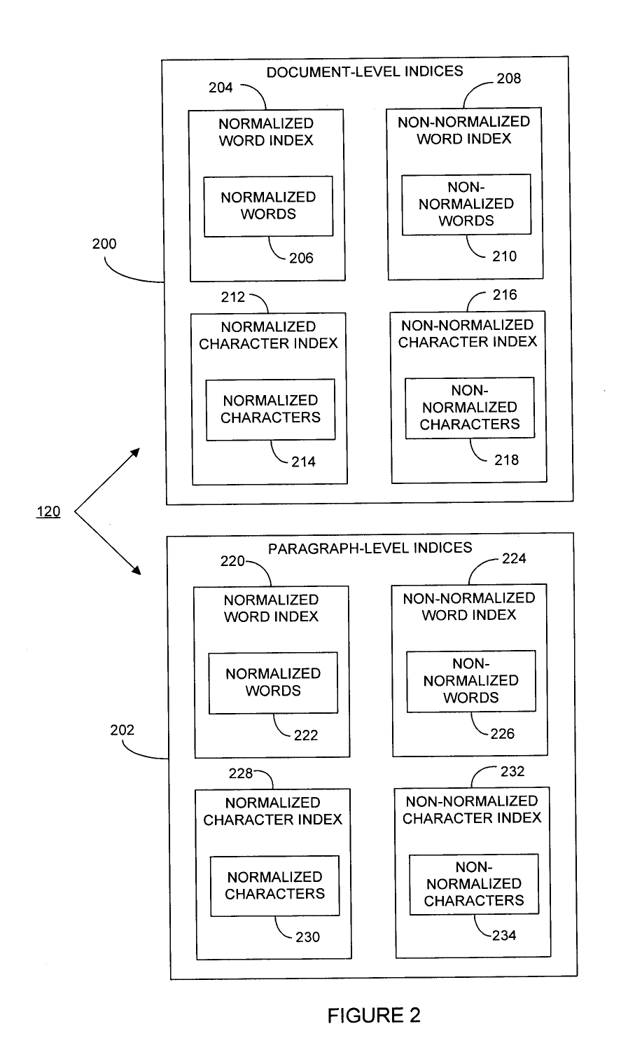

As will be discussed in additional detail below with regard to FIG. 2, each document-level index includes a copy of all of the text in an entire document, such as document 102. Conversely, each paragraph-level index only includes data representative of all of the text in a given paragraph of an entire document, such as document 102. Thus, if document 102 included two paragraphs worth of text, in one example, index engine 128 would be operative to generate (1) a single document-level index including a copy of all of the text in the entire document (i.e., all of the text in each of the two paragraphs) and (2) two separate paragraph level indices, where each individual paragraph-level index includes a copy of all of the text within a single paragraph of the document. As will be discussed in greater below with regard to FIG. 2, in many instances there will be a plurality of indices produced on both a document-level and a paragraph-level.

Once the plurality of indices representative of the obtained text 120 have been generated, the index engine 128 may provide the plurality of indices 120 to the controller(s) 106 for further processing. The controller(s) 106 are operative to generate the user interface 132 based on the plurality of indices representative of the obtained text 120.

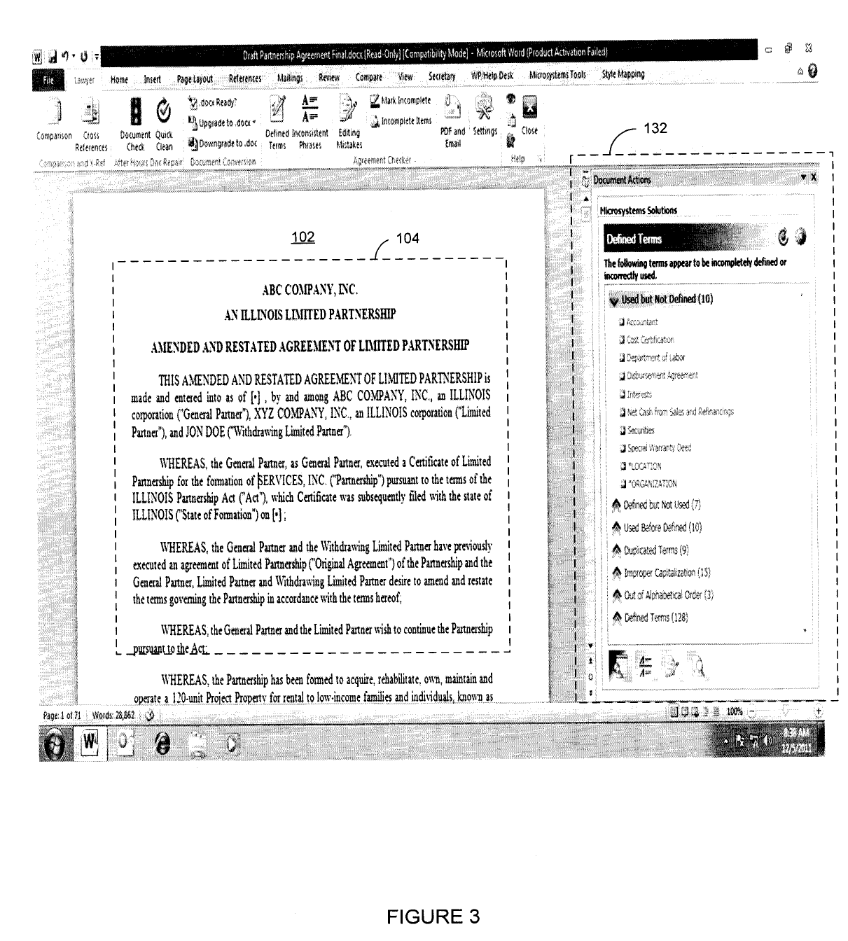

FIG. 3 illustrates an exemplary user interface 132 consistent with the teachings of the instant disclosure. In the example illustrated in FIG. 3, user interface 132 is provided as part of a larger user interface for the word processing program in which the document 102, including text 104, is opened. In this manner, a person using apparatus 100 is capable of viewing both the underlying electronic document 102 and the user interface 132 of apparatus 100 simultaneously. Alternatively, the user interface 132 could be presented separate from, but adjacent to, the word processing program. Techniques for implementing user interfaces, such as user interface 132, are well known to those having ordinary skill in the art.

The user interface 132 of FIG. 3 is shown in a “Defined Terms” mode. In the Defined Terms mode, the user interface 132 includes categories of terms (e.g., letters, words and/or phrases within the document's text 104) that appear to be incompletely defined or incorrectly used based upon determinations made by the pattern engine 130 (in-line with the functionality of the pattern engine 130 described below). For example, a first category is labeled “Used but Not Defined (10).” As an initial matter, the “(10)” indicates that the document's text 104 includes ten terms that are used within the document 102, but that are not supplied with a formal definition within the document text 104. With continued reference to the category Used but Not Defined, the term “Accountant” is contained in the list of terms for this category. This indicates, for example, that the term Accountant is used somewhere within the document text 104, but that the term Accountant is not supplied with a formal definition within the text 104.

The techniques employed for determining which specific terms should occupy categories such as Used but Not Defined are known by those having ordinary skill in the art and will not be discussed in detail herein. However, other categories that may be processed by the pattern engine 130 and suitably included within a user interface 132 in a Defined Terms mode include “Defined but Not Used,” “Used Before Defined,” “Duplicated Terms,” “Improper Capitalization,” “Out of Alphabetical Order,” and “Defined Terms.”

The Defined but Not Used category lists terms that are supplied with a formal definition in the text 104 (e.g., within a “Definitions” section of the text 104), but that are not used anywhere else in the text. The Used Before Defined category lists terms that are generally used in the text before their definition, however, certain exceptions to this rule may exist. For example, page 1 of the document may include the term “120-unit Project Property,” however, this term might not be formally defined until page 5 of the document. Thus, the term “120-unit Project Property” would be displayed within the Used Before Defined category of the user interface 132 in this example. The Duplicated Terms category includes terms that are, for example, of concern because they are defined twice within the same document 102. The Improper Capitalization category includes terms, for example, that are defined within the document (e.g., if the term “Accountant” is formally defined within the document) but that are used within the document without the expected capitalization (e.g., the term “accountant” is found elsewhere in the document without the first “a” being capitalized). The Out of Alphabetical Order category includes defined terms that are listed out of alphabetical order. For example, where the document 102 includes a “Definitions” section, oftentimes the terms that are defined within that section are listed in alphabetical order (e.g., “Accountant” is likely defined before “Cost Certification”). Thus, the Out of Alphabetical Order category lists terms that appear to be out of alphabetical order within the document's text 104. Finally, the Defined Terms category includes terms that are properly defined, as determined by the pattern engine 130.

Although not shown in FIG. 3, the user interface 132 may also operate in additional modes beyond the Defined Terms operating mode described above. For example, the user interface may also operate in an “Inconsistent Phrases” operating mode, whereby phrases that are not used consistently within the text 104 are identified. In another example, the user interface may operate in an “Editing Mistakes” operating mode, whereby common editing mistakes are identified and displayed. For example, anytime an open bracket is provided without a complementary closed bracket, this editing mistake may be displayed on the user interface 132. The foregoing exemplary operating modes are not intended to be exhaustive, and those having ordinary skill in the art will appreciate that other similar operating modes for the user interface 132 may also be provided in accordance with the instant disclosure. As those of ordinary skill in the art will appreciate, the techniques described herein are equally applicable to the various Defined Terms, Inconsistent Phrases, and Editing Mistakes operating modes described herein, or other modes, the operation of which is dependent upon editable documents.

With continued reference to FIG. 3, the user interface 132 is operative to receive input from a user, e.g., though user interaction with a mouse, keyboard, microphone, or any other suitable input mechanism known in the art. For example, if a user were to click a mouse cursor over the term “Accountant” found within the category Used but Not Defined, the view in the word processing program's user interface would change to show the selected instance of the term Accountant within the document. In one example, this functionality may be accomplished by apparatus 100 communicating with the word processing program within which the document is opened via the API discussed above. For example, the apparatus 100 may instruct the word processing program to display the particular instance of the selected term. In one example, the apparatus 100 may further instruct the word processing program via the API to highlight the term that was selected to further delineate the location of the sought after term. The apparatus 100 may use paragraph identification information and relative position information regarding the selected term to instruct the word processing program exactly what to display.

Returning to the discussion of the operation of the apparatus 100 of FIG. 1, once the index engine 128 generates the plurality of indices representative of the obtained text 120, this information 120 may be provided to the pattern engine 130 via the controller(s) 106. In addition, the pattern engine 130 may be provided with secondary attributes data 118. The secondary attributes data 118 is data describing which text 104 of the document has been underlined, italicized, and/or bolded and, as illustrated, is obtained by the controller(s) 106 from the document 102 via, for example, the API. In one embodiment, the secondary attributes data 118 may be obtained at the same time as the initial parsing of the text 104. In another embodiment, the secondary attribute data 118 may be obtained after the initial parsing of the text 104. For example, the secondary attribute data 118 may be obtained when it is needed by the pattern engine 130 to identify patterns in the obtained text 114. As such, in one example, the secondary attribute data 118 may be only obtained as needed, for example, by the pattern engine 130 in identifying patterns within the obtained text 114. In another example, the secondary attribute data 118 may be stored, for example, in storage 504 discussed below with regard to FIG. 5. In any event, based upon the plurality of indices representative of the obtained text 120 and the secondary attributes data 118, the pattern engine 130 is operative to generate pattern data 126. Pattern data 126 describes a particular term contained within the text 104 that should be categorized and displayed by the user interface 132 in accordance with patterns corresponding to the various operating modes as provided above.

In one example, the pattern engine 130 relies upon user-supplied rules (i.e., patterns) to identify terms within the text 104 that meet any of the characteristics of, for example, the Defined Terms operating mode of the user interface 132 described above. For example, a user-supplied rule might provide that a word/phrase that is (1) found within quotation marks and (2) has the first letter capitalized should be treated as a defined term. Accordingly, when the pattern engine 130 identifies a term from the text such as “Accountant” (e.g., by parsing one or more of the plurality of indices representative of the obtained text 120), it treats that term as a defined term and includes that information in the pattern data 126. Thus, because the pattern data 126 is supplied to the user interface 132 via the controller(s) 106, the user interface may display the term “Accountant” within the Defined Terms category (e.g., when the user interface is in the Defined Terms operating mode).

In another example, the pattern engine 130 relies upon pre-defined rules to identify terms within the text 104 that meet any of the characteristics of, for example, the Used but Not Defined Terms operating mode of the user interface 132 described above. This embodiment operates similarly to the embodiment discussed above (i.e., the user-supplied rule embodiment), however, in this embodiment the pattern engine 130 relies upon pre-defined (e.g., hard-coded) rules in performing its processing. For example, a pre-defined rule might state that terms having their first letter capitalized should be considered for inclusion in the Used but Not Defined Terms category. Another pre-defined rule might further refine the universe of candidate Used but Not Defined Terms to those terms having their first letter capitalized that are not found within the Table of Contents section of the document (e.g., because most terms have their first letter capitalized in the Table of Contents). Regardless, after identifying patterns in the text 104 consistent with the pre-defined rules, the pattern engine 130 is operative to include that information in the pattern data 126 for use by the user interface 132.

The foregoing discussion of the operation of apparatus 100 describes an initialization phase that is instituted the first time that the apparatus 100 is used to analyze a document 102 including text 104. However, frequently, a user will want to edit the text 104 of the underlying document 102 while still utilizing the apparatus 100 (e.g., while retaining the user interface 132 on a display screen). Accordingly, it is one object of the present disclosure to provide a user interface 132 that updates substantially in real-time to reflect any changes to the text 104 of the underlying document 102 without user intervention.

To this end, in one example, the apparatus 100 is operative to monitor the document 102 for a change in the text 104. For example, the controller(s) 106 may monitor the document 102 for a change in the text 104. As used herein, monitoring may include, for example, periodically polling the word processing software that the document 102 is open in to determine whether the text 104 has changed since a previous poll. In another example, the word processing software may notify, for example, the controller(s) 106 that the text 104 has been changed by providing, for example, a notification of “a change event” 116. In this manner, the apparatus 100 effectively listens for a change event, where a change event includes an indication that the text 104 has been modified in any way since a previous accounting of the text 104 in the document 102 by apparatus 100 (e.g., a deletion, insertion, or modification of the text 104). For example, those having skill in the art will appreciate that existing word processing software (e.g., Microsoft Word™) is capable of tracking the occurrence of, and sending a notification 116 of, a change event.

Upon detecting a change in the text 104 (e.g., by polling the word processing software or receiving a change event notification 116), the apparatus 100 obtains the changed text 122 from the document 102. As used herein, the changed text 122 may include (1) only that portion of the original text 104 that was changed, (2) a new copy of all of the text from the document 102, including the changed text 122, or (3) the changed text 122 and some portion of the original text that remained unchanged. For example, in one embodiment, where text 104 in a particular paragraph of the document 102 has changed (e.g., one word is changed in the paragraph), the entire paragraph including the changed text (collectively, changed text 122) is provided to the apparatus 100. Accompanying the changed text 122 is location information identifying, for example, (1) the paragraph number of the paragraph including the changed text and (2) the location within that paragraph of the changed text. Regardless, after obtaining the changed text 122 the controller(s) 106 pass the changed text 122 on to the index engine 128 for further processing. The index engine 128 is operative to update the plurality of indices 120, such that the updated plurality of indices 124 are representative of the changed text 122. The updated plurality of indices 124 are then provided to the pattern engine 130 and the user interface 124.

Upon receiving the updated plurality of indices 124, the pattern engine 130 is operative to update the pattern data 126 to reflect the changed text 122. Accordingly, the updated pattern data 126 and the updated plurality of indices 124 are used by the controller(s) 106 to generate an updated user interface 132 reflecting the changed text 122 without user intervention. As used herein, the phrase “without user intervention” means that a user does not need to take any affirmative action (other than changing the text in the underlying document) in order for the user interface 132 to update. This stands in stark contrast to existing tools for analyzing a document where users are required to “refresh” a user interface (e.g., click the mouse cursor on a refresh button that triggers an update process) after making changes to the text of the underlying document. In contrast, in line with the teachings of the present disclosure, merely changing the text 104 in the document 102 is sufficient to trigger the process whereby the apparatus 100 automatically updates the user interface 132 to reflect the changed text 122.

Referring now to FIG. 2, a detailed view of one example of the plurality of indices representative of the obtained text 120 is provided. As shown in FIG. 2, in one example, the plurality of indices representative of the obtained text 120 may include document-level indices 200 and paragraph-level indices 202. In this example, the document level indices 200 include a normalized word index 204, a non-normalized word index 208, a normalized character index 212, and a non-normalized character index 216. In one example, the normalized indices and the non-normalized indices may be generated simultaneously from the obtained text 114.

The document-level normalized word index 204 includes normalized words 206. Normalized words 206 include all words in the obtained text 114. Stated another way, normalized words 206 include all words in the entire document 102, however, the words have been “normalized.” As used herein, normalized means that all of the capitalization associated with the words in the obtained text 114 has been removed. Consider an example where the only text 104 in a document 102 is the phrase “See Spot Run!” (i.e., the obtained text 114 is simply “See Spot Run!”). In this scenario, the document-level normalized word index 204 would include the normalized words 206 “see spot run!”. Thus, the document-level normalized word index 204 includes a normalized set of all of the words in the entire document 102 (where spaces and punctuation marks are treated as being words for the purposes of indexing). Stripping the words of any capitalization information in this manner can provide for processing efficiency gains when, for example, performing pattern recognition with the pattern engine 130.

Conversely, the document-level non-normalized word index 208 includes non-normalized words 210. Non-normalized words 210 include all of the words in the obtained text 114, however, these words have not been “normalized.” That is to say, the non-normalized words 210 retain capitalization information associated with the obtained text 114. Referring back to the above-example where the only text 104 in the document 102 is the phrase “See Spot Run!”, the document-level non-normalized word index 208 would include the non-normalized words 210 “See Spot Run!”. Retaining capitalization information associated with the words in the document 102 assists with, for example, pattern recognition by the pattern engine 130. For example, defined terms within a document 102 often start with a capital letter. Accordingly, the pattern engine 130 can parse the non-normalized word index 208 in order to identify candidate defined terms.

The document-level normalized character index 212 includes normalized characters 214. Normalized characters 214 include all characters in the obtained text 114. However, in line with the above discussion on normalization, all of the capitalization information associated with the obtained text 114 has been removed. Thus, continuing with the example provided above, if the only text 104 in the document 102 is the phrase “See Spot Run!”, then the document-level normalized character index 212 would include the normalized characters 214 “see spot run!”. As with the word indices discussed above, spaces and punctuation marks are treated as characters for the purposes of indexing.

The document-level non-normalized character index 216 includes non-normalized characters 218. Non-normalized characters 218 include all of the characters in the obtained text 114, however, these characters have not been “normalized.” That is to say, the non-normalized characters 218 retain capitalization information associated with the obtained text 114. Again, referring back to the example provided above, if the only text 104 in the document 102 is the phrase “See Spot Run!”; then the document-level non-normalized character index 216 would include the non-normalized characters 218 “See Spot Run!”.

The paragraph-level indices 202 function identically to the document-level indices 200. The only difference being that, in this example, a normalized word index 220, non-normalized word index 224, normalized character index 228, and non-normalized character index 232 are provided for each paragraph in the document 102. Thus, if all of the text 104 in the document 102 is broken up into two paragraphs, then, in this example, there would be eight (8) separate paragraph level indices 202 created for that document 102. These paragraph level indices may exist in addition to any document-level indices 200 that are also generated for a given document 102. While the foregoing discussion describes indices being on either a document-level or a paragraph level, those having ordinary skill in the art will appreciate that indices could suitable be provided on any desirable level of abstraction (e.g., on a sentence-level).

The index engine 128 is able to identify which portions of the obtained text 114 belong to which paragraphs within the document 102 according to unique identifiers assigned to each paragraph in the document. In one embodiment, the word processing software used to create the document 102 includes a function that allows each paragraph to be assigned a unique identifier. That is, the word processing software that the document 102 is open in is able to provide the architecture for the unique identifier, while the controller 106, for example, is capable of assigning a unique value to each paragraph. For example, a unique new sequential value may be assigned to each new paragraph in a document 102 by apparatus 100. Thus, if the document 102 originally included five (5) paragraphs worth of text 104, apparatus 100 would be operative to assign five unique Ids, one to each paragraph worth of text (e.g., ID numbers 1-5). Then, if a new paragraph was added, this new paragraph could be assigned its own unique ID (e.g., ID number 6). Apparatus 100 is operative to keep track of the unique IDs assigned to each paragraph. In this manner, apparatus 100 may instruct the word processing program to change the view within its user interface to depict, for example, the first instance of a Defined Term when that defined term has been selected by a user from user interface 132.

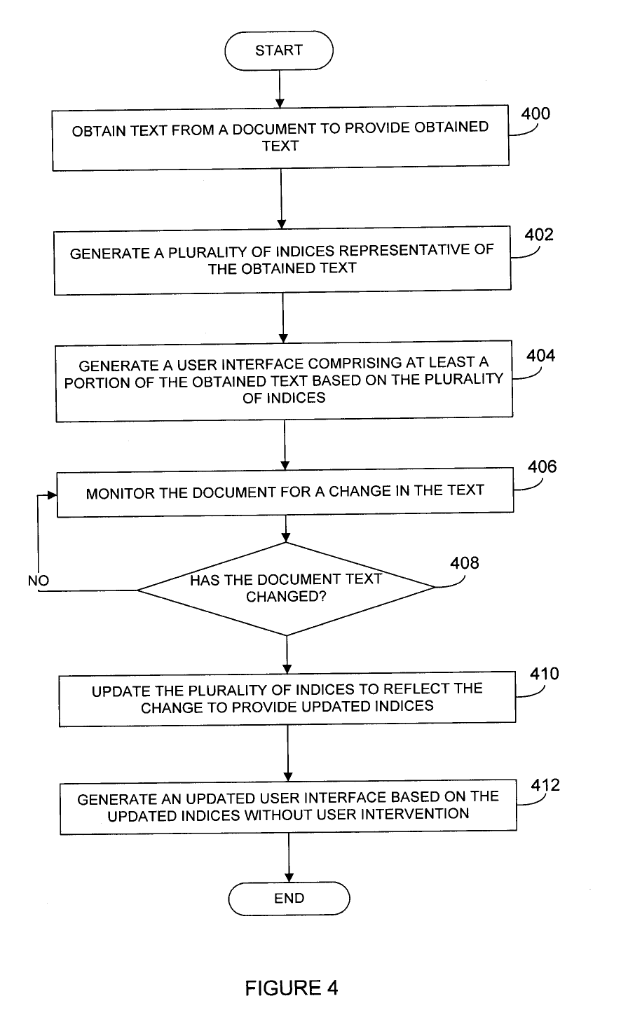

Referring now to FIG. 4, a flowchart illustrating one example of a method for analyzing a document in accordance with the present disclosure is provided. While the apparatus 100 is a form for implementing the processing described herein, those having ordinary skill in the art will appreciate that other, functionally equivalent techniques may be employed. For example, as known in the art, some or all of the functionalities implemented via executable instructions may also be implemented using firmware and/or hardware devices such as application specific integrated circuits (ASICs), programmable logic arrays, state machines, etc. Further still, other implementations of the apparatus 100 may include a greater or lesser number of components than those illustrated. Once again, those of ordinary skill in the art will appreciate the wide number of variations that may be used is this manner.

Beginning at block 400, text is obtained from a document to provide obtained text. At block 402, a plurality of indices representative of the obtained text are generated. At block 404, a user interface is generated. The user interface includes at least a portion of the obtained text based on the plurality of indices that were generated at block 402. At block 406, the document is monitored to detect a change in the text of the document. At block 408, a determination is made as to whether the document text has changed. If it is determined that the document text has not changed, then the process returns to block 406. However, if it is determined that the text has changed, then the method proceeds to block 410. At block 410, the plurality of indices are updated to reflect the change in the text to provide updated indices. Finally, at block 412, an updated user interface is generated based on the updated indices without user intervention.

FIG. 5 illustrates a representative processing device 500 that may be used to implement the teachings of the instant disclosure. The device 500 may be used to implement, for example, one or more components of the apparatus 100, as described in greater detail above. Regardless, the device 500 comprises a processor 502 coupled to a storage component 504. The storage component 504, in turn, comprises stored executable instructions 516 and data 518. In an embodiment, the processor 502 may comprise one or more of a microprocessor, microcontroller, digital signal processor, co-processor or the like or combinations thereof capable of executing the stored instructions 516 and operating upon the stored data 518. Likewise, the storage component 504 may comprise one or more devices such as volatile or nonvolatile memory including but not limited to random access memory (RAM) or read only memory (ROM). Further still, the storage component 504 may be embodied in a variety of forms, such as a hard drive, optical disc drive, floppy disc drive, etc. Processor and storage arrangements of the types illustrated in FIG. 5 are well known to those having ordinary skill in the art. In one embodiment, the processing techniques described herein are implemented as a combination of executable instructions and data within the storage component 504.

As shown, the device 500 may comprise one or more user input devices 506, a display 508, a peripheral interface 510, other output devices 512 and a network interface 514 in communication with the processor 502. The user input device 506 may comprise any mechanism for providing user input (such as inputs selecting a term such as “accountant” from the user interface 132 as described above) to the processor 502. For example, the user input device 506 may comprise a keyboard, a mouse, a touch screen, microphone and suitable voice recognition application, or any other means whereby a user of the device 500 may provide input data to the processor 502. The display 508, may comprise any conventional display mechanism such as a cathode ray tube (CRT), flat panel display, or any other display mechanism known to those having ordinary skill in the art. In an embodiment, the display 508, in conjunction with suitable stored instructions 516, may be used to implement the user interface 132. Implementation of a graphical user interface in this manner is well known to those having ordinary skill in the art. The peripheral interface 510 may include the hardware, firmware and/or software necessary for communication with various peripheral devices, such as media drives (e.g., magnetic disk or optical disk drives), other processing devices or any other input source used in connection with the instant techniques. Likewise, the other output device(s) 512 may optionally comprise similar media drive mechanisms, other processing devices or other output destinations capable of providing information to a user of the device 500, such as speakers, LEDs, tactile outputs, etc. Finally, the network interface 514 may comprise hardware, firmware and/or software that allows the processor 502 to communicate with other devices via wired or wireless networks, whether local or wide area, private or public, as known in the art. For example, such networks may include the World Wide Web or Internet, or private enterprise networks, as known in the art.

While the device 500 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 500 may include a greater or lesser number of components than those illustrated. Once again, those of ordinary skill in the art will appreciate the wide number of variations that may be used is this manner. Further still, although a single processing device 500 is illustrated in FIG. 5, it is understood that a combination of such processing devices may be configured to operate in conjunction (for example, using known networking techniques) to implement the teachings of the instant disclosure.

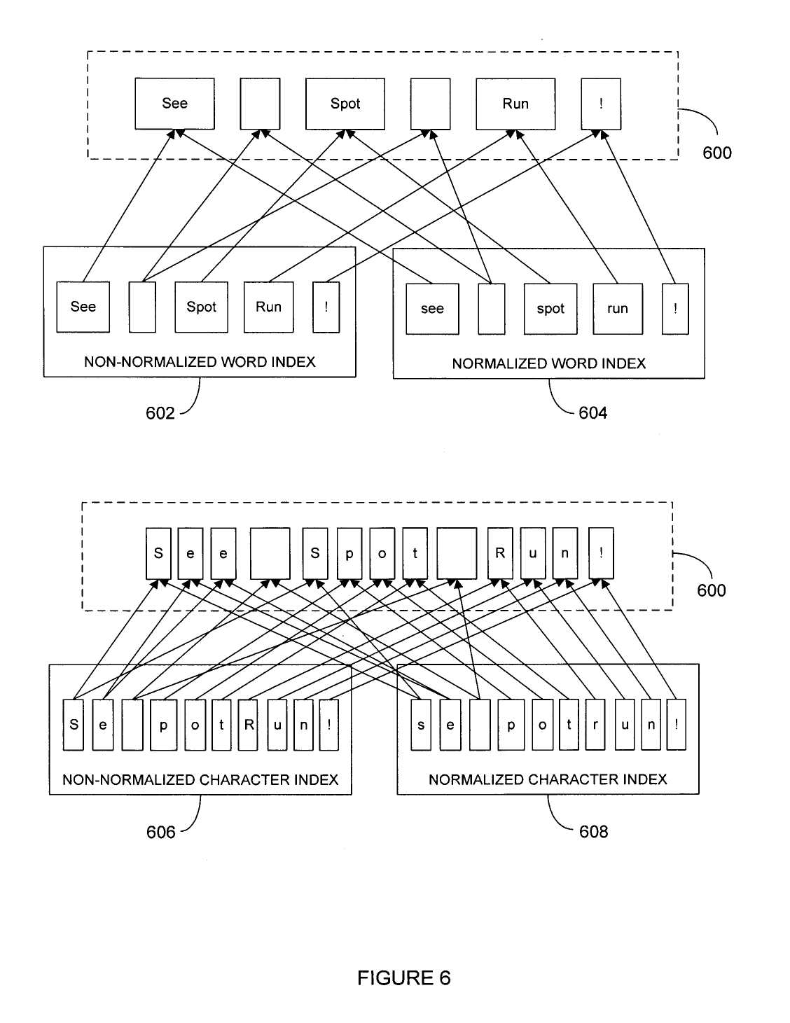

FIG. 6 illustrates one example of a plurality of indices representative of obtained text. In the illustrated example, text 600 represents text that is parsed from a document, such as document 102. For purposes of simplicity, FIG. 6 assumes that the document containing the text only includes a single paragraph worth of text, and that the single paragraph worth of text only includes a single sentence stating “See Spot Run!”. Thus, indices 602-608 could represent document-level indices or paragraph-level indices equally well in this example (because there is only a single, one-sentence paragraph in this example).

The top portion of FIG. 6 depicts one example of how the text 600 may be be stored in word indices in line with the teachings of the instant disclosure. Non-normalized word index 602 includes five entries: (1) the word “See”; (2) a space; (3) the word “Spot”; (4) the word “Run”; and (5) an exclamation point. Because the non-normalized word index 602 is not normalized, the words “See,” “Spot,” and “Run” each retain their capitalization. In addition, the punctuation mark “!” and the space are both treated as words for the purposes of the non-normalized word index 602. Another notable feature of the non-normalized word index 602 is its use of pointers. Rather than storing a separate entry for each instance of the same word in text 600, index 602 utilizes pointers to store a single instance of each word and a pointer (i.e., location information) identifying where other occurrences of that word exist within the document (or paragraph, depending on whether the index is a document-level index or a paragraph-level index). Thus, only a single instance of the space is stored in the non-normalized index 602. The non-normalized word index 602 also stores a pointer indicating that the text 600 includes another space in between the words “Spot” and “Run”.

Similarly, normalized word index 604 includes five entries, treats spaces and punctuation marks as words, and uses pointers to represent multiple instances of the same word. The key difference between the normalized word index 604 and the non-normalized word index 602 is that the normalized word index 604 does not store any capitalization information associated with the text 600.

The bottom portion of FIG. 6 depicts one example of how the same text 600 discussed above may be stored in character indices in line with the teachings of the instant disclosure. Non-normalized character index 606 includes ten entries: (1) the capitalized letter “S”; (2) the lower case letter “e”; (3) a space; (4) a lower case letter “p”; (5) a lower case letter “o”; (6) a lower case letter “t”; (7) an upper case letter “R”; (8) a lower case letter “u”; (9) a lower case letter “n”; and (10) an exclamation point. Because the non-normalized character index is not normalized, the letters “S,” and “R” retain their capitalization. In addition, the punctuation mark “!” and the space are both treated as characters for the purposes of the non-normalized character index 606. Similar to the word indices 602, 604 discussed above, the non-normalized character index 606 also makes use of pointers to store a single instance of each character and a pointer identifying where other occurrences of that character exist within the document (or paragraph, as the case may be). Normalized character index 608 is similar to the non-normalized character index 606 except that capitalization information associated with the text 608 is not retained.

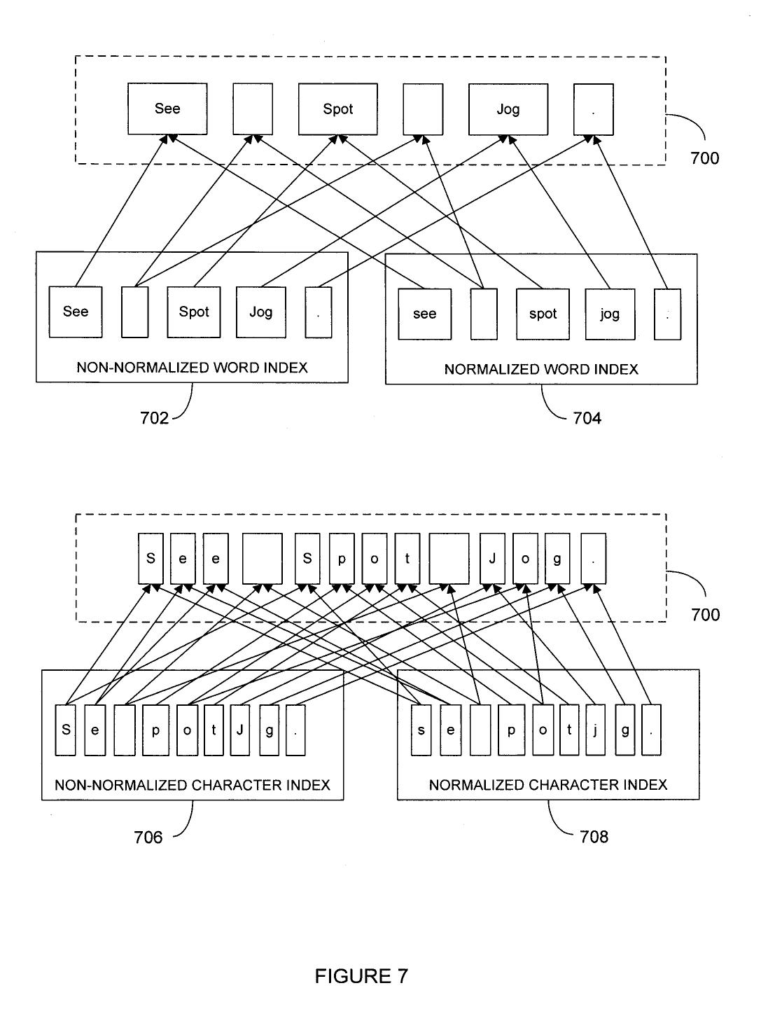

FIG. 7 illustrates a modified version of the plurality of indices presented in FIG. 6 after the text 600 of FIG. 6 has been changed. That is to say, FIG. 7 assumes that a user has modified the original sentence discussed in FIG. 6 from “See Spot Run!” to “See Spot Jog.”. Accordingly, the indices representing the modified text 700 have changed as well. For example, the word “Run” present in non-normalized word index 602 has been replaced by the word “Jog” in non-normalized word index 702. Similarly, the word “run” in normalized word index 604 has been replaced by the word “jog” in normalized word index 704. In addition, the exclamation points present in word indices 602, 604 have been replaced by periods in word indices 702, 704.

With regard to the character indices of FIG. 7, it is clear that the four entries for “R,” “u,” “n,” and “!” that were present in the non-normalized character index 606 of FIG. 6 have been replaced by the three entries “J,” “g,” and “.” in the non-normalized character index 706 of FIG. 7. In addition, non-normalized character index 706 includes an additional pointer from the letter “o”. Specifically, because the text 700 of FIG. 7 now has two “o”s, non-normalized character index 706 includes an additional pointer from the letter “o” when compared with non-normalized character index 606 of FIG. 6. This additional pointer indicates that text 700 also includes the letter “o” between the letters “j” and “g”. Normalized character index 708 stores text 700 in a similar fashion to non-normalized character index 706, except capitalization information associated with the text has not been retained.

The above detailed description and the examples described therein have been presented for the purposes of illustration and description only and not by way of limitation. It is therefore contemplated that the present disclosure cover any and all modifications, variations or equivalents that fall within the spirit and scope of the basic underlying principles disclosed above and claimed herein.

What is claimed is:

1. In at least one processing device, a method for analyzing a document comprising text, the method comprising:
obtaining, by the at least one processing device, the text from the document to provide obtained text;
generating, by the at least one processing device, a plurality of indices representative of the obtained text;
generating, by the at least one processing device, a user interface comprising at least a portion of the obtained text based on the plurality of indices;
monitoring, by the at least one processing device, the document for a change in the text;
in response to detecting a change in the text, updating, by the at least one processing device, the plurality of indices to reflect the change to provide updated indices; and
generating, by the at least one processing device, an updated user interface based on the updated indices without user intervention.

2. The method of claim 1, wherein generating a plurality of indices representative of the obtained text comprises generating at least one document-level index and at least one paragraph-level index.

3. The method of claim 2, wherein generating at least one document-level index comprises generating at least one of:
a normalized word index;
a non-normalized word index;
a normalized character index; and
a non-normalized character index.

4. The method of claim 3, wherein the normalized word index and the non-normalized word index each comprise indices representative of all words in the obtained text, and wherein the normalized word index excludes capitalization information associated with the obtained text.

5. The method of claim 3, wherein the normalized character index and the non-normalized character index each comprise indices representative of all characters in the obtained text, and wherein the normalized character index excludes capitalization information associated with the obtained text.

6. The method of claim 2, wherein generating at least one paragraph-level index comprises generating at least one of:
a normalized word index;
a non-normalized word index;
a normalized character index; and
a non-normalized character index.

7. The method of claim 6, wherein the normalized word index and the non-normalized word index each comprise indices representative of all words within at least one paragraph of the obtained text, and wherein the normalized word index excludes capitalization information associated with the obtained text.

8. The method of claim 6, wherein the normalized character index and the non-normalized character index each comprise indices representative of all characters within at least one paragraph of the obtained text, and wherein the normalized character index excludes capitalization information associated with the obtained text.

9. The method of claim 1, wherein updating the plurality of indices to reflect the change to provide updated indices comprises:
obtaining, by the at least one processing device, changed text from the document; and
modifying, by the at least one processing device, the plurality of indices, such that the modified plurality of indices are representative of the changed text.

10. The method of claim 1, wherein monitoring the document for the change in the text comprises listening, by the at least one processing device, for a change event.

11. An apparatus for analyzing a document comprising text, the apparatus comprising:
at least one processing device; and
memory operatively connected to the at least one processing device, the memory comprising executable instructions that when executed by at least one processing device cause the at least one processing device to:
obtain the text from the document to provide obtained text;
generate a plurality of indices representative of the obtained text;
generate a user interface comprising at least a portion of the obtained text based on the plurality of indices;
monitor the document for a change in the text;
in response to detecting a change in the text, update the plurality of indices to reflect the change to provide updated indices; and
generate an updated user interface based on the updated indices without user intervention.

12. The apparatus of claim 11, wherein the executable instructions, when executed by the at least one processing device, cause the at least one processing device to generate a plurality of indices representative of the obtained text by causing the at least one processing device to generate at least one document-level index and at least one paragraph-level index.

13. The apparatus of claim 12, wherein the executable instructions, when executed by the at least one processing device, cause the at least one processing device to generate at least one document-level index by causing the at least one processing device to generate at least one of:
a normalized word index;
a non-normalized word index;
a normalized character index; and
a non-normalized character index.

14. The apparatus of claim 13, wherein the normalized word index and the non-normalized word index each comprise indices representative of all words in the obtained text, and wherein the normalized word index excludes capitalization information associated with the obtained text.

15. The apparatus of claim 13, wherein the normalized character index and the non-normalized character index each comprise indices representative of all characters in the obtained text, and wherein the normalized character index excludes capitalization information associated with the obtained text.

16. The apparatus of claim 12, wherein the executable instructions, when executed by the at least one processing device, cause the at least one processing device to generate at least one paragraph-level index by causing the at least one processing device to generate at least one of:
a normalized word index;
a non-normalized word index;
a normalized character index; and
a non-normalized character index.

17. The apparatus of claim 16, wherein the normalized word index and the non-normalized word index each comprise indices representative of all words within at least one paragraph of the obtained text, and wherein the normalized word index excludes capitalization information associated with the obtained text.

18. The apparatus of claim 16, wherein the normalized character index and the non-normalized character index each comprise indices representative of all characters within at least one paragraph of the obtained text, and wherein the normalized character index excludes capitalization information associated with the obtained text.

19. The apparatus of claim 11, wherein the executable instructions, when executed by the at least one processing device, cause the at least one processing device to update the plurality of indices to reflect the change to provide updated indices by causing the at least one processing device to:
obtain changed text from the document; and
modify the plurality of indices, such that the modified plurality of indices are representative of the changed text.

20. The apparatus of claim 11, wherein the executable instructions, when executed by the at least one processing device, cause the at least one processing device to monitor the document for the change in the text by causing the at least one processing device to listen for a change event.

21. A computer readable medium comprising executable instructions that when executed by at least one processing device cause the at least one processing device to:
obtain text from a document to provide obtained text;
generate a plurality of indices representative of the obtained text;
generate a user interface comprising at least a portion of the obtained text based on the plurality of indices;
monitor the document for a change in the text;
in response to detecting a change in the text, update the plurality of indices to reflect the change to provide updated indices; and
generate an updated user interface based on the updated indices without user intervention.
